(19) United States
(12) Patent Application Publication
(10) Pub. No.: US 2024/0188199 A1
(43) Pub. Date: Jun. 6, 2024

(54) INDUCTION ENERGY TRANSMISSION SYSTEM

(71) Applicant: BSH Hausgeräte GmbH, Munich (DE)

(72) Inventors: Javier Lasobras Bernad, EJEA DE LOS CABALLEROS (ZARAGOZA) (ES); Sergio Llorente Gil, Zaragoza (ES); Jesus Manuel Moya Nogues, Zaragoza (ES); Jorge Pascual Aza, Zaragoza (ES); Javier Serrano Trullen, Zaragoza (ES); Jorge Tesa Betes, Zaragoza (ES)

(21) Appl. No.: 18/285,661

(22) PCT Filed: Apr. 5, 2022
(86) PCT No.: PCT/EP22/58962

§ 371 Date: Oct. 5, 2023

(30) Foreign Application Priority Data
Apr. 19, 2021 (EP) 21382333

(51) Int. Cl. H05B 6/12; H05B 6/06

(52) U.S. Cl. CPC H05B 6/1236; H05B 6/062; H05B 2213/06

(57) ABSTRACT

An induction energy transmission system includes a support plate, a supply unit arranged below the support plate and including a supply induction element designed to inductively provide energy, a control unit designed to control the supply unit, and a small household appliance for placement on the support plate. The small household appliance includes a receiving induction element designed to receive the inductively provided energy. An operating unit is arranged outside the small household appliance and designed for operation of the small household appliance by a user.

The invention relates to an induction energy transmission system according to the preamble of claim 1 and to a method for operating an induction energy transmission system according to the preamble of claim 10.

Induction energy transmission systems for the inductive transmission of energy from a primary coil of a supply unit to a secondary coil of a small household appliance are already known from the prior art. For example, publication U.S. Pat. No. 3,761,668 A proposes an induction cooktop which, in addition to inductively heating cookware, is also embodied to supply energy to small household appliances, for example to a mixer. Here, energy provided inductively via a primary coil of the induction cooktop is transmitted in part to a secondary coil integrated in the small household appliance.

A disadvantage of induction energy transmission systems already known until now is that each small household appliance to be operated must be controlled by way of a separate operating unit integrated in the small household appliance. This results in the disadvantage on the one hand that users must familiarize themselves with the respective operating units of different small household appliances and in particular during simultaneous operation of multiple small household appliances no shared and uniform operation is possible, as a result of which operating convenience is reduced. In addition, on account of integrated operating units in each small household appliance, the manufacturer incurs disadvantageously high costs which it passes on to the user without however any added value being generated for the user thereby.

The object of the invention consists in particular, but is not restricted thereto, in providing a generic system with improved properties with respect to operating convenience. This object is achieved according to the invention by the features of claims 1 and 10, while advantageous embodiments and developments of the invention can be taken from the subclaims.

The invention is based on an induction energy transmission system, in particular induction cooking system, with a support plate, with a supply unit which is arranged below the support plate and has at least one supply induction element for inductively providing energy, with a control unit for controlling the supply unit, and with at least one small household appliance to be placed on the support plate, wherein the small household appliance has at least one receiving induction element for receiving the inductively provided energy.

It is proposed that the induction energy transmission system has an operating unit arranged outside the small household appliance for operation of the small household appliance by a user.

By means of an embodiment of this type, an induction energy transmission system with a particularly high level of operating convenience can advantageously be provided. Operating convenience is increased in particular by a user being enabled to operate different small household appliances by way of the operating unit arranged outside the small household appliance. The operating unit advantageously provides the user with a uniform user interface for operating different small household appliances so that a particularly intuitive, casy and fast operation can be enabled. Moreover, the user can advantageously be provided with extended operating functions which have not previously been included in this form in particular in small household appliances with just one main function, for example kettles. In addition, a cost saving can advantageously be achieved as a result of the embodiment of the induction energy transmission system according to the invention. Manufacturing costs in particular can be reduced, as a separate operating unit is no longer required in the small household appliance. This cost saving can advantageously be passed on to the user, who can thus purchase particularly cost-effective small household appliances simultaneously having improved operating convenience. Because there is no need for an integrated operating unit in the small household appliance, it is further advantageously also possible to achieve a weight reduction, as a result of which handling for the user and thus an operating experience can be improved. Furthermore, this also enables resources to be saved and it is thus possible to provide a particularly resource-saving and sustainable induction energy transmission system.

The induction energy transmission system has at least one main functionality in the form of a wireless energy transmission, in particular in a wireless supply of energy to small household appliances. In one advantageous embodiment, the induction energy transmission system is embodied as an induction cooking system with at least one main function which differs from a pure cooking function, in particular at least an energy supply and an operation of small household appliances. For example, the induction energy transmission system could be embodied as an induction oven system and/or as an induction grill system. In particular, the supply unit could be embodied as part of an induction oven and/or as part of an induction grill. The induction energy transmission system embodied as an induction cooking system is preferably embodied as an induction cooktop system. The supply unit is then embodied in particular as part of an induction cooktop. In a further advantageous embodiment, the induction energy transmission system is embodied as a kitchen energy supply system and provision can be made for it to provide cooking functions in addition to a main function in the form of an energy supply and an operation of small household appliances. A “support plate” is to be understood to mean an in particular plate-type unit, which is provided for placing at least one small household appliance and/or item of cookware and/or for setting down at least one item of food to be cooked. The support plate could be embodied for example as a worktop, in particular as a kitchen worktop, or as a subregion of at least one worktop, in particular at least one kitchen worktop, in particular of the induction energy transmission system. As an alternative or in addition, the support plate could be embodied as a cooktop plate. The support plate embodied as a cooktop plate could embody in particular at least one part of a cooktop outer housing and, in particular, could at least largely embody the cooktop outer housing together with at least one outer housing unit to which the support plate embodied as a cooktop plate could be connected in at least one assembled state. The support plate is preferably manufactured from a non-metallic material. The support plate could be formed for example at least to a large extent from glass and/or glass ceramic and/or from Neolith and/or from Dekton and/or from wood and/or from marble and/or from stone, in particular from natural stone, and/or from laminate and/or from plastic and/or from ceramic. In the present application, terms indicating positions, such as for example “below”, or “above”, refer to an assembled state of the support plate unless otherwise explicitly described.

A “supply unit” is to be understood in particular to mean a unit which in at least one operating state provides energy inductively and which has in particular a main functionality in the form of a provision of energy. In order to provide energy, the supply unit has at least one supply induction element, which has in particular at least one coil, in particular at least a primary coil, and/or is embodied as a coil and which provides energy inductively in particular in the operating state. The supply unit could have at least two, in particular at least three, advantageously at least four, particularly advantageously at least five, preferably at least eight and particularly preferably several supply induction elements, which in the operating state could in each case provide energy inductively, namely in particular to a single receiving induction element or to at least two or several receiving induction elements of at least one small household appliance and/or at least one further small household appliance. At least some of the supply induction elements could be arranged in proximity to each other, for example in a row and/or in the form of a matrix. The supply unit preferably has at least one power unit. The power unit preferably carries out a frequency conversion in the operating state and converts in particular an input-side low-frequency alternating voltage into an output-side high-frequency alternating voltage. The low-frequency alternating voltage preferably has a frequency of at most 100 Hz. The high-frequency alternating voltage preferably has a frequency of at least 1000 Hz. The power unit is connected to the control unit and can be controlled by the control unit by means of control signals. The power unit is preferably provided to carry out the adjustment of the energy provided by way of the at least one supply induction element by adjusting the high-frequency alternating voltage. The power unit preferably comprises at least one rectifier. The power unit preferably has at least one heating frequency element, which is embodied in particular as a power inverter. The heating frequency element preferably generates an oscillating electrical current for operating the at least one supply induction element, preferably with a frequency of at least 15 kHz, in particular of at least 17 kHz, and advantageously of at least 20 kHz. The power inverter preferably comprises at least two bipolar transistors with isolated gate electrodes and particularly advantageously at least one damping capacitor.

The small household appliance is preferably a household appliance which is not bound to a specific location and which has at least the receiving induction element and at least one functional unit, which provides at least one household appliance function in an operating state. “Not bound to a specific location” is to be understood in this context to mean that the small household appliance can be positioned freely within a household by a user, in particular without auxiliary equipment, in particular as opposed to a large household appliance which is positioned and/or installed in a fixed location, such as for example an oven or a refrigerator. The small household appliance is preferably embodied as a small kitchen appliance and provides at least one household appliance function for processing foodstuffs in the operating state. The small household appliance could, without being limited thereto, be embodied for example as a multifunctional food processor and/or as a mixer and/or as a stirrer and/or as a grinder and/or as kitchen scales or as a kettle or as a coffee machine or as a rice cooker or as a milk frother or as a deep-fat fryer or as a toaster or as a juicer or as a cutter or the like.

The receiving induction element comprises at least one secondary coil and/or is embodied as a secondary coil. In an operating state of the small household appliance, the receiving induction element supplies the functional unit with electrical energy. It is moreover conceivable for the small household appliance to have an energy storage facility, in particular a battery, which is provided to store electrical energy received via the receiving induction element in a charging state and to make the same available to the functional unit in a discharging state.

A “control unit” is to be understood in particular to mean an electronic unit which is provided at least to control and/or regulate the supply unit and to automatically identify the small household appliance placed on the support plate, and which is preferably at least partly integrated into the support plate and/or arranged below the support plate. The control unit preferably comprises a computing unit and in particular in addition to the computing unit at least one memory unit, which provides at least a temporary working memory for the computing unit.

An “operating unit” is to be understood here to mean a unit which has at least one operating element which can be actuated directly by an operator and which is provided to influence and/or to change a process and/or a state of a unit coupled to the operating unit, in particular the control unit and at least one unit of the small household appliance, by way of an actuation and/or an input of parameters. The operating unit is arranged outside the small household appliance. The operating unit could be connected in a detachable manner to the support plate and be embodied for example as a portable touch pad or the like. The operating unit is preferably integrated at least partly in the support plate. The operating unit preferably has at least one operating element which is embodied as a touch display and provided for an input of operating commands by a user and for the output of information, particularly relating to the induction energy transmission system, to the user. Provision is preferably also made for the operating unit to provide at least one display and/or operating function which goes beyond the household appliance function of the small household appliance. It would for example be conceivable for a timer function which is not present in the small household appliance itself to be integrated in the operating unit so that for example a duration of the household appliance function provided by the small household appliance can be displayed to the user via the operating unit.

“Provided” is to be understood to mean especially programmed, configured and/or equipped. An object being provided for a particular function is to be understood to mean that the object fulfills and/or carries out this particular function in at least one application and/or operating state.

A communication between the operating unit arranged outside the small household appliance and the small household appliance could be cable-bound. For example, the operating unit could be embodied as a keyboard or the like, which can be connected via a cable for operation with the small household appliance. In one advantageous embodiment, however, it is proposed that the induction energy transmission system has a communication unit with at least one communication interface for wireless data transmission with the small household appliance. This makes it possible to further improve operating convenience. In addition, it is advantageously possible to achieve a high degree of flexibility. The communication unit is preferably provided for bidirectional wireless data transmission, in other words for both wirelessly receiving and wirelessly sending data.

It is moreover proposed that the communication unit has at least one further communication interface for wireless data transmission between the operating unit and at least one external unit. As a result, it is advantageously possible to improve operator convenience even further. The external unit could be for example, without being limited thereto, a smartphone and/or a smartwatch and/or a tablet and/or a computer and/or a laptop and/or another, in particular mobile device which appears expedient to a person skilled in the art or at least one part of such a device.

It is furthermore proposed that the small household appliance can be operated directly by the external unit by means of wireless data transmission via the communication unit. An embodiment of this type advantageously makes it possible to further increase operating convenience. It would be conceivable, for example, for display and/or operating information to be able to be displayed to a user via an app in the external unit. Operating commands input by the user in an operating state in which the external unit is connected wirelessly to the operating unit via the communication unit can initially be transmitted wirelessly to the operating unit arranged outside the small household appliance and then transmitted from the operating unit via the communication unit to the small household appliance for operation. It is moreover conceivable that a display of the operating unit can be transmitted wirelessly to the external unit via the communication unit.

It is furthermore proposed that the communication unit is embodied for wireless data transmission by means of at least two different data transmission standards. This advantageously makes it possible to achieve a particularly high degree of flexibility. In particular, it is advantageously possible to enable wireless data transmission with a multiplicity of different small household appliances and/or different external units via the communication unit. The communication interface is preferably embodied at least for wireless data transmission by means of the NFC data transmission standard and by means of the WLAN data transmission standard. It is also conceivable, alternatively or in addition, for the communication interface to be embodied for wireless data transmission by means of the Bluetooth data transmission standard and/or the ZigBee data transmission standard and/or the RFID data transmission standard and/or the GPS data transmission standard and/or at least one mobile radio data transmission standard and/or another suitable data transmission standard.

In one advantageous embodiment of the invention, it is proposed that the support plate is embodied as a cooktop plate. An embodiment of this type makes it possible to provide an induction energy transmission system, embodied as an induction cooking system, with the aforementioned advantageous properties, which in addition to inductively supplying energy to small household appliances by way of the supply unit in accordance with the embodiments described above also enables an inductive heating of cookware.

In an alternative advantageous embodiment of the invention, it is proposed that the support plate is embodied as a kitchen worktop. This makes it possible to provide an induction energy transmission system with the aforementioned advantageous properties and with a particularly high level of esthetics and functionality. It is also advantageously possible to increase a fascination for inductive energy transmission if the support plate is embodied as a kitchen worktop, as some components of the induction energy transmission system, in particular the supply unit, remain entirely below the kitchen worktop such that they are invisible to a user and as a result the impression can be given that the small household appliance is operated without any source of energy. In the case of a support plate embodied as a kitchen worktop, too, the induction energy transmission system could be embodied as an induction cooking system, wherein the supply unit, in addition to inductively supplying energy to small household devices, could also be provided to inductively heat cookware.

It is moreover proposed that the operating unit is embodied as a cooktop operating unit. As a result, it is advantageously possible to further increase operating convenience. If the operating unit is embodied as a cooktop operating unit, it is advantageously possible to enable both an operation of the supply unit to provide cooktop functions, in particular a heating of an item of cookware placed on the support plate, and also an operation of the at least one small household appliance via the operating unit.

The operating unit could be arranged at least partly outside the support plate. In one advantageous embodiment, however, it is proposed that the operating unit is integrated in the support plate. This advantageously makes it possible to provide an induction energy transmission system with a particularly high level of functionality and esthetics. Moreover, a space saving can advantageously be achieved.

The invention is further based on a method for operating an induction energy transmission system, in particular in accordance with one of the embodiments described above, with a support plate and with a supply unit which is arranged below the support plate and has at least one supply induction element for inductively providing energy, and with at least one small household appliance to be placed on the support plate, wherein the small household appliance has at least one receiving induction element for receiving the inductively provided energy.

It is proposed that at least one operating command is transmitted to the small household appliance from an operating unit arranged outside the small household appliance during an operation of the small household appliance by a user. A method of this type advantageously makes it possible to enable a particularly user-friendly operation of the small household appliance.

The induction energy transmission system is not to be restricted here to the above-described application and embodiment. In particular, in order to fulfill a mode of operation described here, the induction energy transmission system can have a number of individual elements, components and units which deviates from a number cited herein.

Further advantages result from the following description of the drawing. The drawing shows two exemplary embodiments of the invention. The drawing, the description and the claims contain numerous features in combination. The person skilled in the art will expediently also consider the features individually and combine the same to form useful further combinations.

In the drawing:

FIG. 1 shows an induction energy transmission system with a support plate, a supply unit, a control unit and two small household appliances placed on the support plate in a schematic representation,

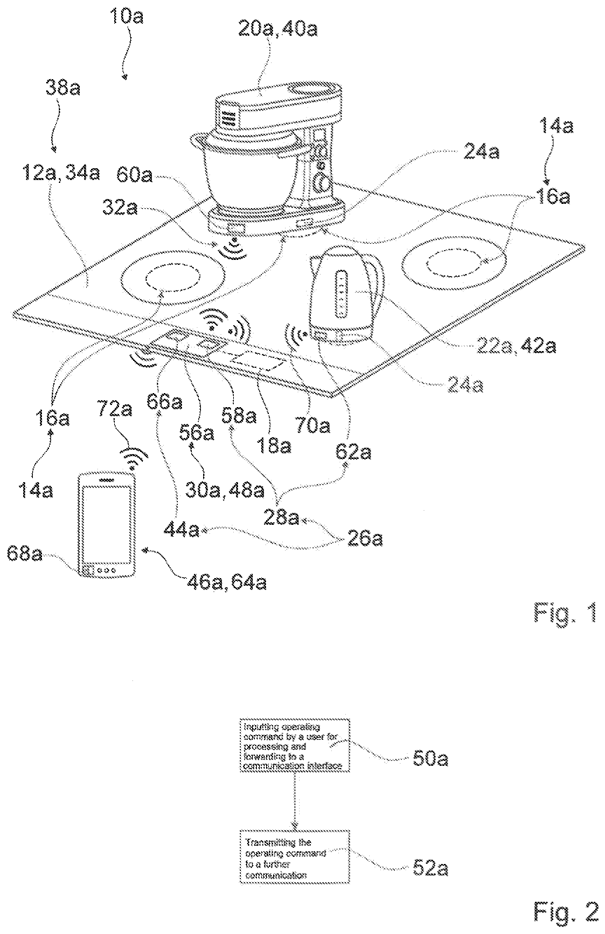

FIG. 2 shows a schematic method flowchart representing a method for operating the induction energy transmission system, and

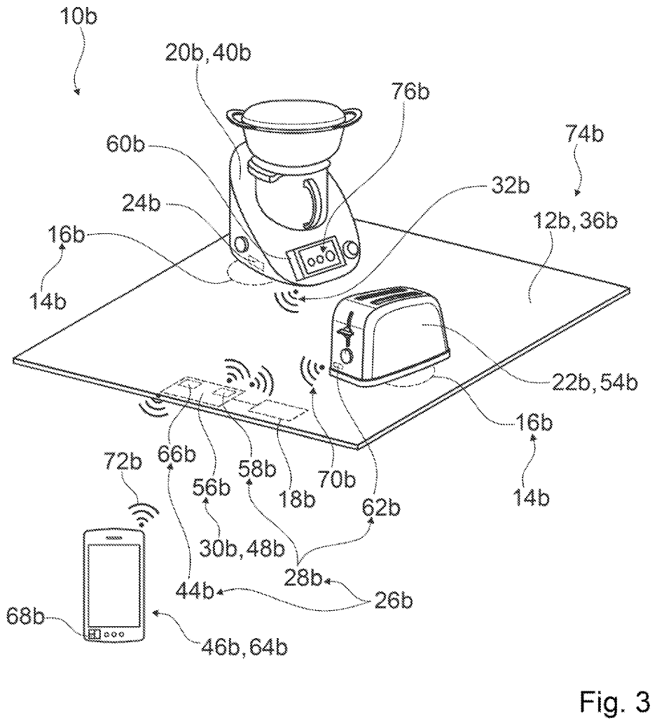

FIG. 3 shows a further exemplary embodiment of an induction energy transmission system with a support plate, a supply unit, a control unit and two small household appliances placed on the support plate in a schematic representation.

FIG. 1 shows an induction energy transmission system 10a in a schematic representation. The induction energy transmission system 10a has a support plate 12a and a supply unit 14a. The supply unit 14a is arranged below the support plate 12a and has at least one supply induction element 16a for inductively providing energy. Here, the supply induction unit 14a has a total of four supply induction elements 16a, which are arranged below the support plate 12a. The induction energy transmission system 10 also has a control unit 18a for controlling the supply unit 14a.

Here, the induction energy transmission system 10a is embodied as an induction cooking system and comprises an induction cooktop 38a. Here, the support plate 12a is embodied as a cooktop plate 34a. The cooktop plate 34a is part of the induction cooktop 38a. In an operating state of the induction cooktop 38a, cookware (not shown) placed on the support plate 12a can be heated inductively by the supply unit 14a.

The induction energy transmission system 10a comprises at least one small household appliance 20a to be placed on the support plate 12a. The small household appliance 20a has at least one receiving induction element 24a. The receiving induction element 24a is provided for receiving inductively provided energy. Here, the receiving induction element 24a is provided for receiving the energy supplied inductively by the supply induction element 16a. Here, the induction energy transmission system 10a comprises the small household appliance 20a and a further small household appliance 22a. The small household appliance 20a is embodied as a food processor 40a and is provided for mixing and/or stirring foodstuffs, among other purposes. The further small household appliance 22a comprises a receiving induction element 24a and is embodied as a kettle 42a.

The induction energy transmission system 10a has an operating unit 30a arranged outside the small household appliance 20a for the operation of the small household appliance 20a by a user (not shown). The operating unit 30a is also arranged outside the further small household appliance 22a and provided for the operation of the further small household appliance 22a by the user. The operating unit 30a is connected to the control unit 18a.

Operating commands that the user inputs via the operating unit 30a in an operating state of the induction cooktop 38a are transmitted from the operating unit 30a to the control unit 18a and converted into control signals for controlling the supply unit 14a.

The operating unit 30a comprises a touch display 56a. The touch display 56a is provided both for the input of the operating commands by the user and also for displaying information relating to the induction energy transmission system 10a.

The operating unit 30a is integrated in the support plate 12a. Here, the operating unit 30a is embodied as a cooktop operating unit 48a, namely as the cooktop operating unit 48a of the induction cooktop 38a.

The induction energy transmission system 10a has a communication unit 26a. The communication unit 26a comprises at least one communication interface 28a for wireless data transmission with the small household appliance 20a. The communication interface 28a is moreover also provided for wireless data transmission with the further small household appliance 22a. The communication interface 28a has a communication interface element 58a. The communication interface element 58a is connected to the operating unit 30a. The communication interface 28a has two further communication interface elements 60a, 62a. The further communication interface element 60a is arranged in the small household appliance 20a and the further communication interface element 62a is arranged in the further small household appliance 22a. The communication interface 28a is embodied as an NFC interface of the communication unit 26a. The communication interface element 58a and the further communication interface elements 60a, 62a are in each case provided for transmitting and receiving data via NFC. The wireless data transmission between the communication interface element 58a and the further communication interface element 60a in the small household appliance 20a takes place via an NFC signal 32a. The wireless data transmission between the communication interface element 58a and the further communication interface element 62a in the small household appliance 22a takes place via a further NFC signal 70a. Operating commands that the user inputs in the touch display 56a to operate the small household appliance 20a and/or the further small household appliance 22b in an operating state of the induction energy transmission system 10a are transmitted wirelessly via the NFC signal 32a to the small household appliance 20a and wirelessly via the further NFC signal 70a to the further small household appliance 22b.

The communication interface 26a also has at least one further communication interface 44a. The further communication interface 44a is provided for wireless data transmission between the operating unit 30a and at least one external unit 46a. Here, the external unit 46a is a smartphone 64a of the user. The further communication interface 44a has a further communication interface element 66a, which is connected to the operating unit 30a and embodied to transmit and receive data via WLAN. The further communication interface 44a is embodied as a WLAN interface of the induction energy transmission system 10a. The wireless data transmission between the operating unit 30a and the external unit 46a takes place via a WLAN signal 72a. The small household appliance 20a and the further small household appliance 22a can in each case be operated by means of wireless data transmission via the communication unit 26 indirectly by way of the external unit 46a. Here, the small household appliance 20a and the further small household appliance 22a can be operated in each case indirectly via the smartphone 64a of the user. In the operating state of the induction energy transmission system 10a, the user can connect their smartphone 64a to the induction energy transmission system 10a by means of a WLAN-capable external communication interface element 68a of the smartphone 64a via the further communication interface 44a. Operating commands that the user then inputs via an app (not shown) on the smartphone 64a are transmitted from the smartphone 64a wirelessly to the operating unit 30a via WLAN over the further communication interface 44a. The operating commands are then transmitted from the operating unit 30a over the communication interface 28a via NFC to the small household appliance 20a and/or the further small household appliance 22a.

The communication unit 26a is embodied for wireless data transmission by means of at least two different data transmission standards. Here, the communication unit 26a is embodied for wireless data transmission according to the NFC data transmission standard and the WLAN data transmission standard. However, it would of course also be possible, as an alternative or in addition, to use other data transmission standards suitable for wireless data transmission, for example Bluetooth, in the induction energy transmission system 10a.

FIG. 2 shows a schematic method flowchart of a method for operating the induction energy transmission system 10a. In the method, a user transmits at least one operating command to the small household appliance 20a to the operating unit 30a arranged outside the small household appliance 20a during operation of the small household appliance 20a. The method comprises at least two method steps. In a method step 50a, the operating command input by the user via the touch display 56a is processed by the operating unit 30a and forwarded to the communication interface element 58a of the communication interface 28a. In a further method step 52a, the operating command is transmitted from the communication interface element 58a to the further communication interface element 60a in the small household appliance 20a.

A further exemplary embodiment of the invention is shown in FIG. 3. The following descriptions are substantially restricted to the differences between the exemplary embodiments, wherein with regard to components, features and functions which remain the same, reference can be made to the description of the exemplary embodiment in FIGS. 1 to 2. In order to differentiate the exemplary embodiments, the letter a in the reference characters of the exemplary embodiment in FIGS. 1 to 2 is replaced by the letter b in the reference characters of the exemplary embodiment of FIG. 3. In principle, reference can also be made to the drawings and/or the description of the exemplary embodiment in FIGS. 1 to 2, in respect of components labeled the same, in particular in respect of components with identical reference characters.

FIG. 3 shows an induction energy transmission system 10b in a schematic representation. The induction energy transmission system 10b has a support plate 12b and a supply unit 14b. The supply unit 14b is arranged below the support plate 12b and has at least one supply induction element 16b for inductively providing energy. Here, the supply induction unit 14b has a total of two supply induction elements 16b, which are arranged below the support plate 12b. The induction energy transmission system 10b has a control unit 18b for controlling the supply unit 14b.

In contrast to the previous exemplary embodiment of the induction energy transmission system 10a shown in FIG. 1, the support plate 12b of the induction energy transmission system 10b is embodied as a kitchen worktop 36b.

The induction energy transmission system 10b has at least one small household appliance 20b. Here, the induction energy transmission system 10b has the small household appliance 20b and a further small household appliance 22b, which in each case have a receiving induction element 16b for receiving inductively provided energy. The small household appliance 20b is embodied as a food processor 40b. In the present exemplary embodiment, the further small household appliance 22b is embodied as a toaster 54b.

Here, the induction energy transmission system 10b is embodied as a multifunctional system and comprises an invisible induction cooktop 74b. Here, the support plate 12b is embodied as a kitchen worktop 36b. The kitchen worktop 36b is part of the invisible induction cooktop 74b. The supply induction elements 16b are arranged below the kitchen worktop 36b such that they are invisible to the user, and in addition to supplying energy to the small household appliance 20b and/or the further small household appliance 22b can also be used to heat cookware (not shown) placed on the kitchen worktop 36b.

The induction energy transmission system 10b has an operating unit 30b arranged outside the small household appliance 20b and outside the further small household appliance 22b for the operation of the small household appliance 20b or the further small household appliance 22b by a user (not shown).

The operating unit 30b comprises a touch display 56b. The touch display 56b is provided both for the input of the operating commands by the user and also for displaying information relating to the induction energy transmission system 10b.

The operating unit 30b is integrated in the support plate 12b. Here, the operating unit is embodied as a cooktop operating unit 48b, namely as the cooktop operating unit 48b of the invisible induction cooktop 74b.

The induction energy transmission system 10b has a communication unit 26b. As in the previous exemplary embodiment, the communication unit 26b has a communication interface 28b and a further communication interface 44b. The communication interface 28b is embodied as an NFC interface and is provided for wireless data transmission between the operating unit 30b and the small household appliance 20b or the further small household appliance 22b. In an operating state the wireless data transmission between the operating unit 30b and the small household appliance 20b takes place between a communication interface element 58b, which is connected to the operating unit 30b, and a further communication interface element 60b, which is integrated in the small household appliance 20b, via an NFC signal 32b. In the operating state the wireless data transmission between the operating unit 30b and the further small household appliance 22b similarly takes place between the communication interface element 58b and a further communication interface element 62b, which is integrated in the further small household appliance 22b, via a further NFC signal 70b.

The further communication interface 44b is embodied as a WLAN interface and is provided for wireless data transmission between the operating unit 30b and at least one external unit 46b. The external unit 46b is embodied as a smartphone 64b of the user. The small household appliance 20b and the further small household appliance 22b can in each case be operated by means of wireless data transmission via the communication unit 26b indirectly by way of the external unit 46b. The wireless data transmission between the external unit 46b and the operating unit 30b takes place via a WLAN signal 72b.

The small household appliance 20b comprises a small household appliance operating unit 76b. The small household appliance operating unit 76b is integrated in the small household appliance 20b. The user can operate the small household appliance 20b directly via the small household appliance operating unit 76b. Via the NFC signal 32b, a display of the small household appliance operating unit 76b can also be transmitted to the touch display 56b of the operating unit 30b and displayed on the touch display 56b. The display of the small household appliance operating unit 76b can also be transmitted to the external unit 46b via the communication unit 26b. In the operating state, the display can be transmitted from the further communication interface element 60b initially to the communication interface element 58b via NFC signal 32b and subsequently via WLAN signal 72b to the external unit 46b. Here, the display of the small household appliance operating unit 76b can thus be displayed on the smartphone 64b, for example in an app (not shown here) on the smartphone 64b.

### REFERENCE CHARACTERS

10 Induction energy transmission system
12 Support plate
14 Supply unit
16 Supply induction element
18 Control unit
20 Small household appliance
22 Further small household appliance
24 Receiving induction element
26 Communication unit
28 Communication interface
30 Operating unit
32 NFC signal
34 Cooktop plate
36 Kitchen worktop
38 Induction cooktop
40 Food processor
42 Kettle
44 Further communication interface
46 External unit
48 Cooktop operating unit
50 Method step
52 Further method step
54 Toaster
56 Touch display
58 Communication interface element
60 Further communication interface element
62 Further communication interface element
64 Smartphone
66 Further communication interface element
68 External communication interface element
70 Further NFC signal
72 WLAN signal
74 Invisible induction cooktop
76 Small household appliance operating unit

1-10. (canceled)

11. An induction energy transmission system, comprising:
a support plate;
a supply unit arranged below the support plate and comprising a supply induction element designed to inductively provide energy;
a control unit designed to control the supply unit;
a small household appliance for placement on the support plate, said small household appliance comprising a receiving induction element designed to receive the inductively provided energy; and
an operating unit arranged outside the small household appliance and designed for operation of the small household appliance by a user.

12. The induction energy transmission system of claim 11, constructed in a form of an induction cooking system.

13. The induction energy transmission system of claim 11, further comprising a communication unit comprising a communication interface designed for wireless data transmission with the small household appliance.

14. The induction energy transmission system of claim 13, wherein the communication unit comprises a further communication interface designed for wireless data transmission between the operating unit and an external unit.

15. The induction energy transmission system of claim 14, wherein the small household appliance is operable by wireless data transmission via the communication unit indirectly by way of the external unit.

16. The induction energy transmission system of claim 13, wherein the communication unit is designed for wireless data transmission via at least two different data transmission standards.

17. The induction energy transmission system of claim 11, wherein the support plate is embodied as a cooktop plate.

18. The induction energy transmission system of claim 11, wherein the support plate is embodied as a kitchen worktop.

19. The induction energy transmission system of claim 11, wherein the operating unit is embodied as a cooktop operating unit.

20. The induction energy transmission system of claim 11, wherein the operating unit is integrated in the support plate.

21. A method for operating an induction energy transmission system which comprises a support plate, a supply unit arranged below the support plate and comprising a supply induction element designed to inductively provide energy, and a small household appliance designed for placement on the support plate and comprising a receiving induction element designed to receive the inductively provided energy, the method comprising:
transmitting an operating command to the small household appliance from an operating unit arranged outside the small household appliance for operation of the small household appliance by a user.

22. The method of claim 21, further comprising providing wireless data transmission via a communication interface of a communication unit with the small household appliance.

23. The method of claim 22, further comprising providing wireless data transmission via a further communication unit of the communication unit between the operating unit and an external unit.

24. The method of claim 23, further comprising operating the small household appliance by wireless data transmission via the communication unit indirectly by way of the external unit.

25. The method of claim 22, further comprising designing the communication unit for wireless data transmission via at least two different data transmission standards.

26. The method of claim 21, further comprising embodying the support plate as a cooktop plate.

27. The method of claim 21, further comprising embodying the support plate as a kitchen worktop.

28. The method of claim 21, further comprising embodying the operating unit as a cooktop operating unit.

29. The method of claim 21, further comprising integrating the operating unit in the support plate.
